(19) United States
(12) Patent Application Publication
(10) Pub. No.: US 2012/0042020 A1
(43) Pub. Date: Feb. 16, 2012

(54) MICRO-BLOG MESSAGE FILTERING

(75) Inventors: Pranam Kolari, San Jose, CA (US); Ruiqiang Zhang, Cupertino, CA (US); Yi Chang, Sunnyvale, CA (US); Anlei Dong, Fremont, CA (US); Zhaohui Zheng, Sunnyvale, CA (US); Lei Duan, San Jose, CA (US)

(73) Assignee: Yahoo! Inc., Sunnyvale, CA (US)

(21) Appl. No.: 12/857,000

(22) Filed: Aug. 16, 2010

(51) Int. Cl. G06F 15/16

(52) U.S. Cl. 709/206

(57) ABSTRACT

Example methods, apparatuses, or articles of manufacture are disclosed that may be implemented using one or more computing devices to provide or otherwise support micro-blog message filtering.

### BACKGROUND

1. Field

The present disclosure relates generally to search engine information management systems and, more particularly, to micro-blog message filtering techniques for use with search engine information management systems.

2. Information

Social communication arrangements supported by the Internet, such as, for example, on-line social networks or web-based personalized virtual communities continue to evolve. As geographic barriers to personal travel decrease and society becomes more mobile, a desire to access or share information from a variety of places or at a variety of times or to stay connected while on the move increases. Continued advancements in information technology, communications, mobile applications, etc. help to bring on-line social networking from users' desktops into a mobile or wireless world. Today, a number of on-line social networking services feature one or more mobile communication platforms that allow users to socialize while on the move. Mobile social networking is gradually becoming more widespread.

A form of on-line social networking, mobile or otherwise, may include, for example, micro-blogging that enables micro-blog users or members to broadcast their current status or otherwise share information about their interests, activities, opinions, etc. in relatively short posts distributed via a number of communication avenues or channels, including, for example, instant messaging, Short Messaging Service (SMS) or Multimedia Messaging Service (MMS) messages, e-mail, etc. to members of a social network. Micro-blog posts or messages may also be displayed on a member profile homepage for other group members to view, for example. Typically, although not necessarily, micro-blog posts or messages may be written or communicated on-the-go using a variety of portable communication devices, such as, for example, cellular telephones, personal digital assistants (PDA), laptop computers, tablet personal computers (PC), or the like. Shorter posts or messages may lower the investment of users' time and thought, thus, making micro-blogging more conversational, casual, and, thus, more appealing. Micro-blog posts or messages may also be shared by members across one or more social networks and, at times, openly published on the Web.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating an implementation of an example computing environment.

FIG. 2 is an illustrative representation of a screenshot view depicting short informal messages from micro-blog users.

FIG. 3 is a flow diagram illustrating an implementation of a process for predicting micro-blog message forwarding or “re-tweets.”

FIG. 4 is a schematic diagram illustrating an implementation of a computing environment associated with one or more special purpose computing apparatuses.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, articles, systems, etc. that would be known by one of ordinary skill have not been described in detail so as not to obscure claimed subject matter.

Some example methods, apparatuses, or articles of manufacture are disclosed herein that may be implemented to effectively or efficiently filter information transmitted or communicated within one or more social networking or communication contexts, such as, for example, a micro-blogging communication context. As used herein, “filtering” may refer to one or more information processing tasks in which certain information (e.g. unwanted, redundant, irrelevant, etc.) may be removed from an information stream so as to prioritize, sort, or otherwise pass information through based, at least in part, on some reference characteristics, attributes, terms, properties, features, preferences, indicators, or other like criteria. One or more information filtering techniques may be used, for example, by a search engine or other like information management system to determine how to respond to a search query or perform other information processing functions. More specifically, as illustrated in example implementations described herein, one or more filtering techniques may be utilized to predict forwarding of a short informal message, sometimes also referred to as a “re-tweet,” by one or more networking parties within one or more social networks, for example, in a domain of micro-blogging. As used herein, “micro-blogging” may refer to a web-based form of communication or networking in which parties (e.g., members, users, subscribers, clients, etc.) may post or broadcast, for example, their current status (e.g., what a networking party is doing at the moment, etc.) or otherwise share information about their interests, activities, opinions, etc. via one or more short informal messages or posts distributed to or capable of being viewed by members of a social network, such as, for example, a micro-blogging social network. In addition, in certain example implementations, one or more information filtering techniques may be utilized to facilitate or support one or more ranking mechanisms (e.g., indexing, locating, retrieving, ranking, etc.) employed by information management systems, such as search engines. For example, in one particular implementation, one or more filtering techniques may be utilized for real-time ranking of relevant or useful short informal messages or posts associated with a particular micro-blog in response to a query, though claimed subject matter is not so limited.

As used herein, “short informal message,” “micro-post,” “micro-blog message,” “twitter-type message,” “tweet,” “message,” or the plural form of such terms may be used interchangeably and may refer to one or more messages posted or communicated within at least one social network, typically, although not necessarily, no more than a few sentences long, which are not bound by rigid writing rules, styles, or standards. Short informal messages may be distributed to members of a network, such as a social network, via a communications channel or medium, such as, for example, instant messaging, Short Messaging Service (SMS) or Multimedia Messaging Service (MMS) communications, e-mail, etc. or may be displayed on a member (e.g., author or originator of a message, forwarding user, etc.) profile homepage for other group members to view. As a way of illustration, micro-blogging platforms or services may include Twitter, Jaiku, Tumblr, Plurk, Beeing, just to name a few examples. In addition, social networking web-sites, such as Facebook, MySpace, Linkedln, XING, etc. may also feature a micro-blogging platform or component allowing users, for example, to post or otherwise communicate status updates publicly or within a certain group. Typically, although not necessarily, in this context, “social network” may refer to a communications network or web-based social grouping of individuals, such as, for example, an on-line virtual community who may share interests, ideas, activities, opinions, events, etc. by posting content via a communications network, such as the Internet (e.g., on on-line bulletin boards, discussion forums, blogs, profile homepages, etc.), wherein individual members of the group may be represented by nodes, and relationships between members may be represented by associational links or ties, for example. It should be appreciated that example methods, apparatuses, or articles of manufacture disclosed herein may be implemented in or otherwise supported by any social network, such as, for example, a micro-blogging social network including those mentioned above, as well as those not listed or developed in the future.

Effectively or efficiently identifying or locating popular content on the Web may facilitate or support information-seeking behavior of searching parties, thus, leading to an increased usability of a search engine. As such, due, at least in part, to increasing popularity of micro-blogging, a number of search engines may attempt to include, for example, relevant or useful short informal messages or posts associated with one or more micro-blogs or the like in a listing of returned search results. Global relevance in terms of, for example, readership across one or more social networks (e.g., widespread, etc.) of certain micro-blog messages may be less than desirable, however, since a somewhat subjective nature of short informal status updates may be more relevant to an immediate social network of a particular member, thus, making these messages somewhat less interesting to a larger audience. Thus, identifying short informal messages with less subjectivity or broader appeal, for example, such as messages that are popular, interesting, or news-worthy, may help to locate micro-blog content that may be useful or relevant to a larger audience (e.g., beyond an immediate social network, etc.). For example, on-line social networking behavior associated with a micro-blogging concept or model in which a party may choose which micro-bloggers to “follow” or which messages to forward may help in identifying popular or sufficiently informative (e.g., useful or relevant to a wider audience, etc.) short informal messages.

As will be described in greater detail below, “following” in the context of the present disclosure may refer to a social networking concept or model in which a party termed “follower” or “following” member may choose whom to “follow” to receive short informal messages or posts without being required to seek or obtain a permission from a “followed” member first. A “followed” member may typically, although not necessarily, include a message originator or author, for example, whose posts or short informal messages are being followed by one or more “following” members. In turn, a “following” member may also be “followed” by others without granting permission first. As a way of illustration, a “follower” or “following” member may receive or notice an interesting or otherwise news-worthy short informal message or post and may re-post or forward the message so that his or her “followers” can see it too. Thus, similarly to in-links on popular web-pages where more in-links tend to receive more visitors and, thus, may be considered to be more relevant or useful, a number of times a short informal message has been forwarded or re-posed may also reflect on its popularity or readership (e.g., global relevance, etc.) so as to be considered more socially relevant or useful (e.g., more immediate, more informative, etc.) to a larger audience across one or more social networks.

Today, a number of search engines are capable of returning micro-blog content gathered or indexed in real time, for example, by streaming in or otherwise monitoring one or more sources of information, updated instantly or nearly instantly (e.g., via subscription feeds, etc.) or otherwise, associated with a micro-blogging domain, as was indicated. As the terms used herein, “real time” or “instantly” may refer to an amount of timeliness of electronic signals or electronic information which has been delayed by an amount of time attributable to electronic communication or signal processing. Typically, although not necessarily, real-time search engines rank short informal messages or posts, at least in part, ordered by time (e.g., freshness, etc.) or by relevance using a set of short informal messages or posts collected or archived over a certain period of time, such as, for example, a relatively small number of recent days. In certain situations, however, search engines retrieving or surfacing fresh posts may be overwhelmed with a live stream of micro-blog content, for example, which may affect or impair an ability to recognize or locate and, thus, rank, posts that are more relevant or useful to a larger audience. In addition, search engines overwhelmed with a live stream of micro-blog content may be more prone to micro-post misclassifications resulting in ranking irrelevant or unwanted content, such as spam, self-promotion, etc.

Certain search engines monitoring micro-blog content may identify more informative messages, such as, for example, popular or news-worthy posts, based, at least in part, on the number of times one or more posts were forwarded or re-posted, sometimes referred to as a “re-tweet.” Although a sufficiently reliable popularity estimation of posts may be obtained within some amount of time based, at least in part, on actual re-posting and forwarding information, real-time search results may suffer in terms of coverage or ranking due, at least in part, to a time-sensitive nature and, thus, somewhat shorter half-life of popular or news-worthy micro-posts, for example. To illustrate, after a short informal message has been posted, a search engine may experience one or more delays attributable to noticing a message (e.g., by “followers,” etc.) and to identifying or computing forwarded or re-posted messages, for example. As such, given a shorter half-life of popular or news-worthy micro-posts, effectively or efficiently predicting micro-blog message forwarding, for example, at, upon or soon after creation or posting may improve or extend overall utility. In turn, extended utility may make messages more “visible” to various search engines, thus, effectively or efficiently supporting one or more ranking mechanisms (e.g., indexing, locating, ordering, etc.) utilized by these engines and, as such, increasing usability.

In addition to ranking, a task of micro-blog message filtering in connection with, for example, effectively or efficiently predicting re-posting or forwarding of short informal messages may have implications in terms of a corporate marketing strategy (e.g., monitoring consumer opinion concerning brands, etc.), public relation intelligence, news-worthy or unexpected event broadcasting, or the like. As a way of illustration, predicting micro-blog message re-posting or forwarding may save a monetary amount, for example, by timely addressing public relation issues in business or corporate world (e.g., intercepting employee rumors, addressing merger or acquisition news, preventing trade secret leaks, etc.). Also, predicting micro-blog message re-posting or forwarding may help with respect to unexpected or life-saving events (e.g., earthquake or flood early warning alerts, breaking news reports, etc.). Predicting micro-blog message re-posting or forwarding may also help in uncovering or identifying potential interesting or news-worthy posts (e.g., useful or relevant across one or more social networking communities, etc.) that would otherwise go unnoticed. Accordingly, it may be desirable to develop one or more methods, systems, or apparatuses that may be used to effectively or efficiently implement micro-blog message filtering so as to, for example, predict re-posting or forwarding one or more short informal messages within at least one social network or to facilitate or support ranking relevant short informal messages in response to a real-time query, just to illustrate a few possible implementations.

As will be described in greater detail below, one or more filtering features may be determined or identified based, at least in part, on past or previous (e.g., historic, etc.) behavior of parties or members with respect to posting, re-posting, or forwarding short informal messages within a particular micro-blogging social network, also referred to as a “re-tweet.” As was previously mentioned, one or more filtering features may be used to facilitate or support one or more filtering tasks or operations, such as, for example, a task or operation of predicting that a short informal message may be forwarded or may be likely to be forwarded or a task or operation of ranking socially relevant or useful micro-blog content (e.g., during real-time information searches, etc.), though claimed subject matter is not so limited. More specifically, one or more representative terms may be identified, such as, for example, one or more indicator terms represented, at least in part, by tokens of text present or embedded in short informal messages that were forwarded and those that were not forwarded. Indicator terms may be processed in some manner using, for example, one or more language-modeling techniques so as to generate, for example, one or more sample sets of content-level features. In addition, one or more user-related terms represented, at least in part, by tokens of text present or embedded in short informal messages may be identified, and one or more sample sets of user-level features may also be generated. As will be described in greater detail below, in an implementation, one or more user-related terms may identify a party or user (e.g., authoring a short informal message, etc.), for example, and may indicate whether a short informal message was transmitted by a user whose short informal messages may tend to get forwarded. As will also be seen, social networking relationship between “followed” users and “following” users or “followers” may also be considered, and one or more features relating to a measure of a user network authority may be computed. A learning function (e.g., employing one or more machine-learning techniques) may be trained based, at least in part, on one or more information samples associated with at least one or more sets of filtering features (e.g., user-level features, content-level features, social network authority feature, etc.) so as to establish one or more machine-learned functions. In certain example implementations, a machine-learned function may comprise, for example, a prediction function or a ranking function established in connection with accessing one or more training sets or collections of information, such as, for example, a collection of short informal messages representing previous user behavior information, an index representing “following” relationship information, or a set of query-message pairs labeled by human editors to reflect relevance.

In one particular implementation, a prediction function may be utilized, for example, to identify one or more digital signals representing one or more features for predicting that a short informal message may be forwarded or may be likely to be forwarded at, upon, or soon after creation or posting within at least one social network. In an implementation, a ranking function may be utilized or applied, for example, at a query time to compute relevance or ranking scores of short informal messages to determine a particular order of ranking based, at least in part, on one or more filtering features reflecting relevance of short informal messages to a query. Of course, descriptions of a prediction function, ranking function, or their applications are merely examples, and claimed subject matter is not limited in this regard.

Certain filtering features may be used, for example, by an indexer or like process or function to establish or maintain an index or like collection of information accessible by a classifier, to illustrate one possible implementation. Certain information associated with an index may be used, for example, by a classifier or like process or function (e.g., a prediction function, etc.) to classify a short informal message as one that may be forwarded or as one more likely to be forwarded. In addition, certain information associated with an index may be used (e.g., by a ranking function, etc.), for example, to rank socially relevant or useful short informal messages based, at least in part, on one or more filtering features relevant to a query. Results of a micro-blog message filtering may be implemented for use with a search engine or other like information management system, for example, responsive to search queries, in real-time searches or otherwise, though claimed subject matter is not so limited.

Before describing some example methods, apparatuses, or articles of manufacture in greater detail, sections below will first introduce certain aspects of an example computing environment in which information searches may be performed, or in which one or more micro-blog message filtering techniques may be advantageously utilized. It should be appreciated, however, that techniques provided herein and claimed subject matter are not limited to this example implementation. For example, techniques provided herein may be used in a variety of information processing environments, such as database applications, language model processing applications, on-line or off-line transaction or relational computing models, such as may be implemented by a special purpose computing device or system. In this context, typically, although not necessarily, “model” may refer to a conceptual representation of one or more aspects of a system, operation, or approach, existing or to be constructed, for example, which may present knowledge, partially, dominantly, or substantially, of a system, operation, or approach in one or more usable forms. In addition, any implementations, embodiments, configurations, or examples described herein are described primarily for purposes of illustration and are not to be construed as preferred or desired over other implementations, embodiments, configurations, or examples.

The World Wide Web, or simply the Web, may provide a vast array of information accessible worldwide and may be considered as an Internet-based service organizing information via use of hypermedia (e.g., embedded references, hyperlinks, etc.). Considering the large amount of resources available on the Web, it may be desirable to employ a search engine to help locate or retrieve relevant or useful information, such as, for example, one or more documents of a particular subject or interest. A “document,” “web document,” or “electronic document, as the terms used herein, are to be interpreted broadly and may include one or more stored signals representing any source code, text, image, audio, video file, or like information that may be read or processed in some manner by a special purpose computing apparatus and may be played or displayed to or by a searching party or client. Documents may include one or more embedded references or hyperlinks to images, audio or video files, or other documents. For example, one type of reference that may be embedded in a document and used to identify or locate other documents may comprise a Uniform Resource Locator (URL). As a way of illustration, documents may include a blog post, a short informal message or post, an e-mail, an SMS message, an MMS message, an Extensible Markup Language (XML) document, a web page, a media file, a page pointed to by a URL, just to name a few examples.

In the context of a search, a query may be submitted via an interface, such as a graphical user interface (GUI), for example, by entering certain words or phrases to be queried, and a search engine may return a search results page, which may include a number of documents typically, although not necessarily, listed in a particular order. Under some circumstances, it may also be desirable for a search engine to utilize one or more techniques or processes to rank documents so as to assist in presenting relevant or useful search results in an efficient or effective manner. Accordingly, a search engine may employ one or more functions or operations to rank documents estimated to be relevant or useful based, at least in part, on relevance scores, ranking scores, or some other measure of relevance such that more relevant or useful documents may be presented or displayed more prominently among a listing of search results (e.g., more likely to be seen by a searching party or client, more likely to be clicked on, etc.). Typically, although not necessarily, for a given query, a ranking function may determine or calculate a relevance score, ranking score, etc. for one or more documents by measuring or estimating relevance of one or more documents to a query. As used herein, a “relevance score” or “ranking score” may refer to a quantitative or qualitative evaluation of a document based, at least in part, on one or more aspects or features of that document and a relation of one or more aspects or features to one or more queries. As one example among, many possible, a ranking function may utilize one or more filtering features associated with particular documents relevant to a query and may determine a relevance or ranking score based, at least in part, thereon. A relevance or ranking score may comprise, for example, a signal sample value or score (e.g., on a pre-defined scale) calculated or assigned to a document and may be used, partially, dominantly, or substantially, to rank documents with respect to a query, for example. It should be noted, however, that these are merely illustrative examples relating to relevance or ranking scores, and that claimed subject matter is not so limited. Following the above discussion, in processing a query, a search engine may place documents that are deemed to be more likely to be relevant or useful (e.g., with higher relevance scores, ranking scores, etc.) in a higher position or slot on a returned search results page, and documents that are deemed to be less likely to be relevant or useful (e.g., with lower relevance scores, ranking scores, etc.) may be placed in lower positions or slots among search results, for example. A searching party or client, thus, may, for example, receive and view a web page or other electronic document that may include a listing of search results presented, for example, in decreasing order of relevance, to illustrate one possible implementation.

In an implementation, one or more real-time searching techniques may be utilized, for example, to return relevant or useful information in response to a query, as previously mentioned. With a large amount of information being added to the Web daily, particularly in a micro-blogging domain, for example, maintaining an up-to-date index via a crawl may be a challenging or computationally expensive task. Typically, although not necessarily, a crawler may perform a new crawl or update an index of documents periodically. Constraints, such as size of the Web, cost or finite nature of bandwidth for conducting crawls, especially of deep Web resources, for example, may contribute to slower network scan rates. As a result, query returns may produce results that are less relevant or useful or those that have been moved or deleted. As was previously mentioned, certain real-time search engines may facilitate or support quicker indexation, for example, by streaming in or monitoring real-time content at, upon, or soon after its creation or publication on a social network (e.g., via a “firehose,” subscription feeds, etc.) such that content may be found while it may still be considered relevant or useful. In certain situations, however, search engines may be overwhelmed with a live stream of micro-blog content, for example, which may affect or impair ability to recognize relevant or useful micro-blog messages, such as messages that are more interesting, popular, or news-worthy so as to be more relevant or useful to a larger audience, as was also indicated. Accordingly, as described herein by way of example, one or more micro-blog message filtering techniques may help to identify or “catch-up” these short informal messages, for example, so as to effectively or efficiently support information searches by making relevant or useful micro-blog content more “visible” or available for real-time searching or indexing.

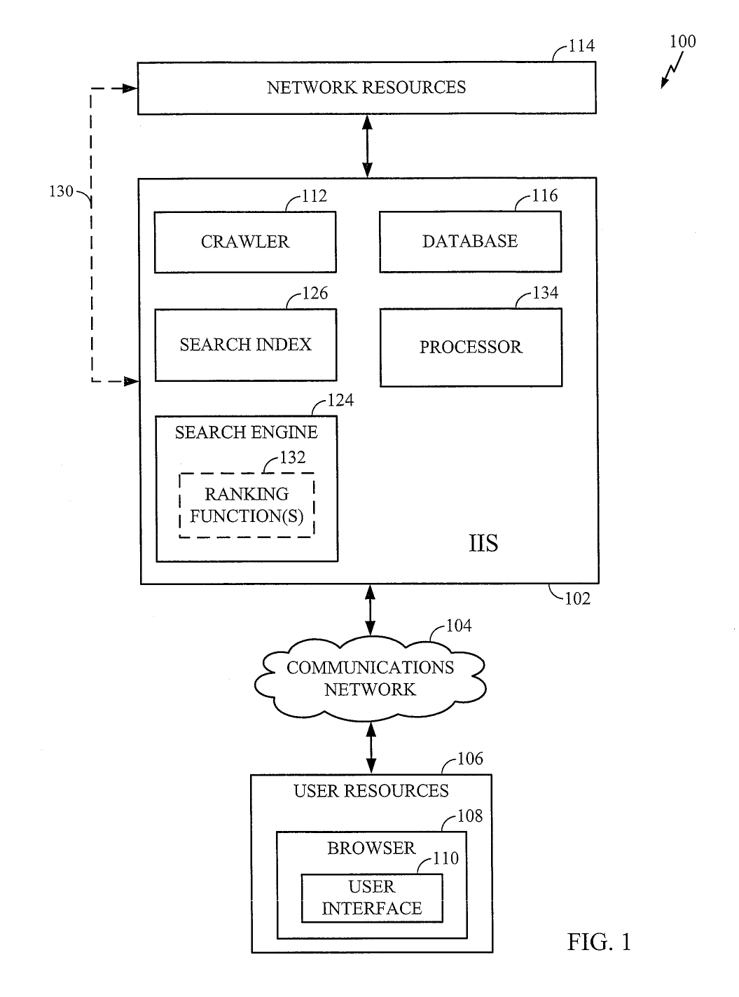

Attention is now drawn to FIG. 1, which is a schematic diagram illustrating certain functional features of an implementation of an example computing environment 100 capable of facilitating or supporting, in whole or in part, one or more processes associated with micro-blog message filtering. Example computing environment 100 may be operatively enabled using one or more special purpose computing apparatuses, information communication devices, information storage devices, computer-readable media, applications or instructions, various electrical or electronic circuitry and components, input signal information, etc., as described herein with reference to particular example implementations.

As illustrated in the present example, computing environment 100 may include one or more special purpose computing platforms, such as, for example, an Information Integration System (IIS) 102 that may be operatively coupled to a communications network 104 that a searching party or client may employ in order to communicate with IIS 102 by utilizing resources 106. Resources 106, for example, as shown, may comprise one or more special purpose computing devices or systems. It should be appreciated that IIS 102 may be implemented in the context of one or more information management systems associated with public networks (e.g., the Internet, the World Wide Web) private networks (e.g., intranets), public or private search engines, Real Simple Syndication (RSS) or Atom Syndication (Atom)-based applications, etc., just to name a few examples.

Again, resources 106 may comprise, for example, any kind of special purpose computing device (e.g., mobile device, PDA, etc.), such as for communicating or otherwise having access to the Internet via a wired or wireless network, for example. Resources 106 may include a browser 108 and an interface 110 (e.g., a GUI, etc.) that may initiate transmission of one or more electrical digital signals representing a query. Browser 108 may facilitate access to or viewing of documents via the Internet, for example, such as HTML web pages, pages formatted for mobile devices (e.g., WML, XHTML Mobile Profile, WAP 2.0, C-HTML, etc.), or the like. Interface 110 may interoperate with any suitable input device (e.g., keyboard, mouse, touch screen, digitizing stylus, etc.) or output device (e.g., display, speakers, etc.) for interaction with resources 106. Even though a certain number of resources 106 are illustrated in FIG. 1, it should be appreciated that any number of resources may be operatively coupled to IIS 102 via, for example, any suitable communications network, such as communications network 104, for example.

In one particular implementation, IIS 102 may employ a crawler 112 to access network resources 114 that may include, for example, any organized collection of information, for example, in the form of binary digital signals, accessible via the Internet, the Web, one or more servers, etc. or associated with one or more intranets (e.g., documents, sites, pages, databases, discussion forums or blogs, query logs, audio, video, image, or text files, etc.). Crawler 112 may follow one or more links or ties (e.g., hyperlinks, etc.) associated with documents, nodes, etc. and may store all or part of a document, node, etc. (e.g., URLs, etc.) in a database 116, for example. IIS 102 may further include a search engine 124 supported by an index, such as, for example, a search index 126. Search engine 124 may be operatively enabled to search for information associated with network resources 114. For example, search engine 124 may communicate with interface 110 and may retrieve for display via resources 106 a listing of search results associated with search index 126 in response to one or more digital signals representing a query.

Network resources 114 may include any organized collection of any type of information, for example, in the form of binary digital signals, accessible over the Internet or associated with an intranet (e.g., micro-blogs, documents, web sites, databases, discussion forums, query logs, audio, video, image, or text files, and the like). As was indicated, in some implementations, network resources 114 may include historic information representing posting or forwarding behavior of micro-blog users or “following” information so as to facilitate or support one or more micro-blog message filtering tasks, such as, for example, predicting micro-blog message forwarding or ranking relevant posts. Optionally or alternatively, information, such as in the form of binary digital signals, may be stored in database 116 or search index 126, for example.

In certain implementations, information associated with search index 126 may be generated. As was indicated, it may be advantageous to utilize one or more real-time indexing techniques or processes, for example, to keep search index 126 sufficiently updated with real-time content. IIS 102 may be operatively enabled to subscribe, for example, to one or more social networking or micro-blogging platforms or services via a feed, such as a direct feed, as indicated generally by dashed line at 130. By way of example, IIS 102 may be enabled to subscribe to the Twitter streaming application programming interface (API) or Twitter firehose feed, thus, having Twitter content streamed in real time (e.g., at, upon, or soon after tweet creation or publication, etc.) so as to facilitate or support real-time searches with respect to a Twitter micro-blogging platform, for example. Of course, this is merely one possible example, and claimed subject matter is not so limited.

As previously mentioned, it may be desirable for a search engine to employ one or more processes to rank search results to assist in presenting relevant or useful information in response to a query. Accordingly, IIS 102 may employ one or more ranking functions, indicated generally by dashed lines at 132, to rank search results in an order that may, for example, be based, at least in part, on a relevance score (e.g., to a query, etc.). In one particular implementation, ranking function(s) 132 may determine, at least in part, relevance scores for short informal messages or posts based, at least in part, on one or more filtering features capturing, for example, relevance between posts and a query, as will be described in greater detail below. In certain example implementations, for example, ranking order for a given query may be determined, for example, by considering contributions from multiple instances of query matches with respect to different sets of filtering features, as will also be seen. It should be noted that ranking function(s) 132 may be included, partially, dominantly, or substantially, in search engine 124 or, optionally or alternatively, may be operatively or communicatively coupled to it. As illustrated, IIS 102 may further include a processor 134 that may be operatively enabled to execute special purpose computer-readable code or instructions or to implement various processes associated with example environment 100, for example.

In operative use, a searching party or client may access a particular search engine website (e.g., www.yahoo.com, http://search.twitter.com, http://tweetmeme.com/search, etc.), for example, and may submit or input a query by utilizing resources 106. Browser 108 may initiate communication of one or more electrical digital signals representing a query from resources 106 to IIS 102 via communication network 104. IIS 102 may look up search index 126 and establish a listing of documents based, at least in part, on relevance scoring according to ranking function(s) 132, for example. IIS 102 may communicate a listing to resources 106 for displaying via interface 110.

With this in mind, example techniques will now be described in greater detail that may be implemented, partially, dominantly, or substantially, to efficiently or effectively filter information, for example, in the form of binary digital signals, such as, one or more short informal messages transmitted or communicated within or across one or more social networking or similar on-line communities or groups, for example. As was indicated, example techniques presented herein may be implemented in the context of micro-blogging, though claimed subject matter is not so limited. More specifically, as illustrated in example implementations described herein, one or more filtering features may be designed or identified based, at least in part, on previous (e.g., historic, etc.) behavior of parties with respect to posting or forwarding short informal messages within a particular micro-blogging social network. One or more filtering features may be used, for example, to facilitate or support one or more filtering tasks or operations, such as predicting that a short informal message may be forwarded or may be likely to be forwarded, or a task of ranking relevant or useful micro-blog content (e.g., during real-time search, etc.). Of course, these are merely examples relating to filtering tasks to which claimed subject matter is not limited.

As a way of illustration, in an implementation, certain information associated with historic short informal messages posted and forwarded within a particular micro-blogging platform may be collected (e.g., over a certain time period, etc.) or archived. Information in the form of binary digital signals may be collected or archived, for example, as two linguistic corpora representing short informal messages that were forwarded and short informal messages that were not forwarded (e.g., posted only), respectively, just to illustrate one possible implementation. “Linguistic corpus” or in the plural form, “linguistic corpora” may typically, although not necessarily, refer to an organized collection of any suitable linguistic units or compounds, such as words, letters, digits, characters, tokens of text, phrases, sentences, paragraphs, or the like that may be processed in some manner (e.g., via statistical analysis, occurrences checking, applied linguistic rules, etc.) and may, for example, be stored as binary digital signals on a suitable storage medium. Using one or more language modeling techniques, one or more representative terms associated with language models of short informal messages that were forwarded and those that were not forwarded may be identified. Typically, although not necessarily, a “language model” may refer to one or more conceptual representations (e.g., statistical, rule-based, etc.) that may capture or otherwise express one or more aspects or properties of a language (e.g., natural, artificial, constructed, formal, symbolic, etc.) in some manner based, at least in part, on one or more sample values, which may, partially, dominantly, or substantially, be attributed to or otherwise associated with a language. For example, in one particular implementation, one or more sample values may comprise, in whole or in part, one or more representative terms, such as, for example, one or more tokens of text present or embedded in short informal messages, as previously mentioned.

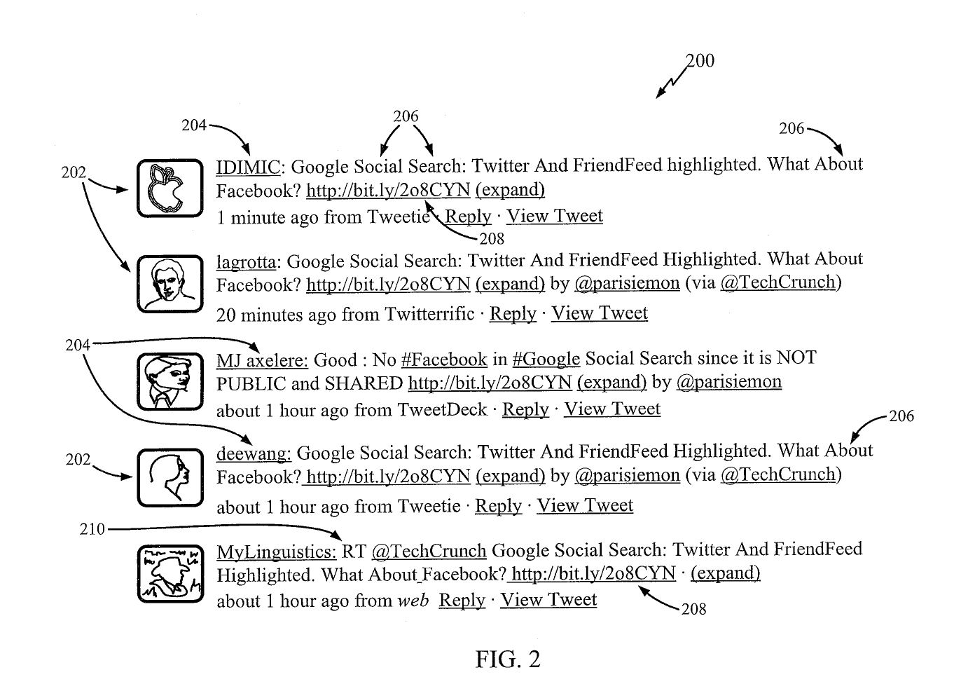

By way of example, FIG. 2 illustrates a representation of a screenshot 200 depicting micro-blog posts or short informal messages 202 from parties or members, indicated generally at 204 via usernames, of the micro-blog Twitter (e.g., www.twitter.com), although claimed subject matter is not limited to this particular micro-blogging platform. Here, tokens of text may comprise, for example, words “social,” “search,” “about,” etc., as indicated generally at 206, just to name a few illustrative examples. As seen, short informal messages or posts 202 may also include one or more embedded resource identifiers, such as, for example, one or more URLs 208. In one particular implementation, URLs 208 may be provided in a shortened form to allow posting or viewing from a variety of portable communication devices (e.g., on-the-go, etc.) or to facilitate micro-blog usability by encouraging linking to relevant information. As depicted in this particular example, a shortened URL may comprise a resource identifier “http://bit.ly/2o8CYN” shortened via a URL shortening service BIT.LY (e.g., http://bit.ly). Of course, various other URL shortening services may also be utilized, such as, for example, TinyURL (e.g., www.tinyurl.com). As illustrated by reference numeral 210, a short informal message or post that was forwarded or re-posed may be prefixed or preceded, for example, by the abbreviation “RT” followed by “c” with a username to give credit to an original posting member (e.g., message originator, author, etc.), such as “RT@TechCrunch” in the example shown. A forwarded message may further include one or more separator tokens (e.g., (:;( )-#!, etc.) that may include whitespace, for example, followed by content of an original message. It should be noted that various other tokens, such as, for example, foreign language-based (e.g., Japanese, Chinese, etc.) words, letters, digits, characters, etc. may also be recognized or considered so as to facilitate or support one or more processes associated with micro-blog message filtering. In addition, it should be appreciated that claimed subject matter is not limited in scope to employing the micro-blogging platform shown or to the approach employed by this particular platform. Rather, this is merely provided as an example of an implementation including micro-blog message filtering capability based, at least in part, on certain information collected via a Twitter streaming API or performing a crawl of Twitter network resources, as will be seen.

As a way of illustration and following the discussion above, one or more language modeling techniques may include, for example, building or establishing a number of language models or operations to distinguish between embedded content or texts of short informal messages or posts that were forwarded and those that were not forwarded. For example, linguistic or text styles of forwarded and non-forwarded micro-posts may differ in terms of word distribution, grammar, writing styles, emotion (e.g., via shorthand notations, etc.), or the like. For instance, typically, although not necessarily, parties may use more informational or formal words to compose or create higher quality or more interesting posts, whereas less interesting posts may include shorter or somewhat more subjective or informal vocabulary. Of course, such an observation relating to various linguistic differences is provided herein by way of example, and claimed subject matter is not limited in this regard.

In one particular implementation, two language models or operations, such as, for example a language model representative of forwarded short informal messages or posts and a language model representative of non-forwarded short informal messages or micro-posts may be built or established. For example, two language models or operations may be established using one or more sets of information, such as, for example, two linguistic corpora of forwarded and non-forwarded posts (e.g., collected over a certain period of time, etc.) utilizing one or more suitable language modeling tools or applications.

For example, a two trigram language model or operation may be established using the Stanford Research Institute Language Modeling (SRILM) toolkit or software package available under an Open Source Community License from SRI International of Menlo Park, Calif. at http://www.speech.sri.com/projects/srilm/, though claimed subject is not limited in this regard. In addition, one or more information smoothing techniques, such as, for example, Good-Turing frequency estimation may be employed to smooth or adjust one or more frequency signal sample values, for example. Thus, in an implementation or embodiment, for example, a language model or operation may comprise, for example, a back-off type language model, meaning that if a higher order of N-gram is unseen in a training dataset (e.g., two linguistic corpora), it may be satisfactorily approximated by a lower order N-gram.

In one particular implementation, a log-likelihood (LL) test may be used, for example, to share or account for one or more characteristics of two language models or operations by comparing relative term frequencies within models or operations associated with two linguistic corpora (e.g., forwarded and non-forwarded posts) so as to quantify term coincidence. It should be appreciated that in certain implementations various other language processing techniques or models facilitating or supporting statistical term selection, such as, for example, chi-square, Naïve-Bayes, logistic regression, or the like may also be considered.

By way of example, but not limitation, two classes of representative terms present or embedded in short informal messages or posts may signify those that tend to be forwarded and those that tend not to be forwarded, respectively. Some examples of two classes of representative terms, which may herein also be called indicator terms, associated with language models of forwarded posts and non-forwarded posts may include those shown in an example case of a unigram in Table 1 and Table 2 below, respectively. As seen, indicator terms featuring in non-forwarded language model (LM) of Table 1 may be considered somewhat informal or less formal, with a higher degree of subjectivity, or arguably more interesting to a particular member or group than to a larger audience, for example, across a social network. As seen in the example of Table 2, indicator terms associated with a language model (LM) of forwarded posts may be considered more news-worthy, popular, or somewhat less subjective so as to potentially be more relevant or interesting to a larger audience. It should be appreciated that indicator terms provided herein are merely examples to which claimed subject matter is not limited. Various other terms (e.g., indicator or representative terms, etc.) not listed that may be present or embedded in short informal messages or posts may also be considered.

TABLE 1
Example indicator terms in non-forwarded posts.

| | | |
|---|---|---|
| i | my | so |
| im | me | lol |
| was | just | :) |
| but | it | u |
| :d | that | going |
| am | watching | yeah |
| got | haha | oh |
| :( | work | (: |
| had | then | its |
| hey | good | like |
| been | sleep | go |
| back | bored | #mobsterworld |
| hope | gonna | bed |
| ok | cant | home |
| wait | homework | school |
| class | tired | night |

TABLE 2
Example indicator terms in forwarded posts.

| | | |
|---|---|---|
| #iranelection | #tcot | social |
| #quote | #ff | new |
| your | #thugs | marketing |
| our | blog | obama |
| #p2 | check | tea |
| #tlot | success | iphone |
| article | follow | up |
| #followfriday | free | get |
| win | top | #jesus |
| #sex | retweet | business |
| #teaparty | socialist | white |
| communist | socialism | health |
| facebook | #truth | list |

In certain example implementations, language model processing techniques may include, for example, calculating or determining a language model-based relevance or ranking score, which may herein also be called a language model score, for one or more posts or short informal messages associated with two linguistic corpora (e.g., forwarded and non-forwarded) in the developed models or operations (e.g., unigram, bigram or trigram). By way of example, given a post comprising a word sequence w₀, w₁, . . . , w_{N}, a language model score P, in an example case of a trigram, may be defined as:

$$P ( {w}_{0} {w}_{1 } … {w}_{N} ) = P ( {w}_{0} ) P ( {w}_{1} \vert P ( {w}_{0} ) {\prod }_{i = 2}^{N} P ( {w}_{i} \vert {w}_{i - 1} {w}_{i - 2} ) \qquad ( 1 )$$

In one particular implementation, a normalized log sample signal value LOGP may be employed, for example, as a language model score, though claimed subject matter is not so limited. For purposes of explanation, LOGP may refer, for example, to a logarithm of a score normalized by the size of a short informal message or post N. Thus, consider:

$$LOG P ( {w}_{0} {w}_{1} … {w}_{N} ) = \frac{log ( p ( {w}_{0} {w}_{1 } … {w}_{N} ) )}{N} \qquad ( 2 )$$

In an implementation, a sample set of content-level features may be generated based, at least in part, on one or more language model scores for one or more posts associated, for example, with two linguistic corpora (e.g., a language model score of a forwarded corpus, a language model score of a non-forwarded corpus, etc.). In this context, content-level features may refer to one or more features based, at least in part, on embedded content or text of a post or short informal message that may indicate, for example, whether content of a message is more likely to be of a broader interest or of use to a wider audience (e.g., more relevant, interesting, etc.).

By way of example, but not limitation, some example content-level features are presented in Table 3 below, which may be taken into consideration, in whole or in part, to facilitate or support one or more micro-blog message filtering techniques. More specifically, one or more content-level features may be utilized to classify a short informal message posted in real time as one more likely to be forwarded based, at least in part, on comparison of its language model (e.g., represented by one or more content-level features, etc.) to language models of posts associated with forwarded or non-forwarded linguistic corpora. As a way of illustration, a short informal message posted in real time may be classified as one more likely to be forwarded if its language model is representative, for example, of a language model of one or more posts associated with a forwarded linguistic corpus. Thus, in certain implementations, language model-based similarities may be used to predict post or micro-blog message forwarding. In addition, in an implementation, one or more content-level features may be utilized, in whole or in part, to facilitate or support one or more ranking mechanisms in connection with real-time information searching or indexing, as was previously mentioned. For example, a ranking function may utilize one or more content-level features to consider one or more representative terms present or embedded in a post (e.g., candidate for ranking, etc.) to better capture relevance between a post and a query, just to illustrate one possible implementation. Of course, details relating to classifying a post or short informal message as one more likely to be forwarded or to ranking of posts are merely examples, and claimed subject matter is not so limited.

As presented in Table 3 below, in one particular implementation, content-level features may be generated using various statistical measures or metrics related, for example, to term frequency distributions, such as within one or more linguistic corpora. For example, statistical measures or metrics may include a parameter or factor intended to represent one or more frequency distributions for or within one or more respective linguistic corpora via any of a host of possible approaches. In an implementation in which one or two linguistic corpora may employed, as examples, one or more of the following may be applied: a subtraction of a language model score of a forwarded corpus from a language model score of a non-forwarded corpus, for example, to generate a φₗₘ_{_{—}}_{sub} feature; a division of a language model score of a non-forwarded corpus by a language model score of a forwarded corpus, for example, to generate a φₗₘ_{_{—}}_{div} feature; a language model score of a non-forwarded corpus, for example, representative of a φₗₘ_{_{—}}ₙₒᵣₜ feature; a language model score of a forwarded corpus, for example, representative of a φₗₘ_{_{—}}ᵣₜ feature; or any combination thereof. It should be appreciated that, virtually without limit, any of a variety of possible other statistical measures or metrics may be utilized to account for distribution of various terms or properties with respect to one or more corpora, linguistic or otherwise, such as, for example, a median, a mean, a mode, a percentile of mean, a number of instances, a ratio, a rate, a frequency, an entropy, mutual information, etc., or any combination thereof.

TABLE 3
Example language model-based content-level features.

| | |
|---|---|
| φₗₘ_{_{—}}_{sub} | forwarded language (LM) model score subtracted from |
| | non-forwarded LM score |
| φₗₘ_{_{—}}_{div} | non-forwarded LM score divided by forwarded LM score |
| φₗₘ_{_{—}}ₙₒᵣₜ | LM score using non-forwarded language model |
| φₗₘ_{_{—}}ᵣₜ | LM score using forwarded language model |

As another potential example or implementation, posts that tend to get forwarded more may include an embedded reply indicator (e.g., “@” or “/” followed by a username, etc.) or a URL, such as, for example, shortened URL 208 of FIG. 2. Accordingly, in certain example implementations, in addition to or instead of one or more language model-based features described above, one or more binary features, such as one or more direct binary features, for example, may also be generated or considered. For example, a binary feature φ_{tinyurl} (e.g., represented by a binary value, etc.) may signify or reflect a presence of a resource identifier in a post or short informal message, and a binary feature φ_{reply} (e.g., represented by a binary value, etc.) may signify or reflect a presence of a reply indicator in a post or short informal message. One or more binary values may be based, at least in part, on an occurrence of a reply indicator or a URL in a short informal message, for example, wherein particular signal sample values may comprise a number of times a message includes a reply indicator or a URL, to illustrate one possible implementation. Although claimed subject matter is not limited in scope in this respect, one or more binary features may be included in a sample set of content-level features, for example, to facilitate or support training one or more prediction or ranking functions, as will be described in greater detail below. Of course, these are merely examples relating to binary features that may be used, in whole or in part, to facilitate or support one or more micro-blog message filtering techniques, and claimed subject matter is not limited in this regard.

In an implementation, one or more sample sets of user-level features may be generated based, at least in part, on previous (e.g., historic, etc.) behavior of parties with respect to posting or forwarding short informal messages within a particular social network, as was indicated. As a potential example, members whose posts have tended to be noticed and forwarded in the past may tend to attract higher interest such that their posts may be more likely to be forwarded. For example, without limitation, these members may comprise potential news-breakers, popular or influential micro-blog users that may have a certain authority across their social network. In this context, user-level features may refer to one or more features accounting for one or more attributes of a micro-blog user or member creating or posting short informal messages or posts that may be more likely to be forwarded, for example. As was discussed, parties or members may be identified via one or more user-related terms represented, at least in part, by tokens of text, such as, for example, usernames 204 of FIG. 2, present or embedded in a short informal message, such as message 202. It should be noted that various other user-related terms not illustrated may be present or embedded in short informal messages so as to facilitate or support one or more processes associated with generating one or more sets of user-level features, for example.

In one implementation, a sample set of user-level features may comprise, for example, those illustrated in Table 4 below. One or more user-level features may be generated, for example, using any of a host of possible or various statistical measures or metrics, such as a mean, a deviation, a total, etc., just to name a few. For example, a φₘₑₐₙ_{_{—}}ᵣₜ feature may be generated by computing a mean value of forwarded short informal messages for messages posted by a particular micro-blog user or member. Thus, a member with a higher φₘₑₐₙ_{_{—}}ᵣₜ value may be expected to produce posts that are more likely to be forwarded. Illustrative non-limiting examples of members having higher φₘₑₐₙ_{_{—}}ᵣₜ values may include, for example, news-breakers, celebrities, or members having political or religious themes, as seen in Table 5 below. Likewise, a φ_{sd}_{_{—}}ᵣₜ feature may account for a consistency aspect of a micro-blog message forwarding, for example, by determining a standard deviation value of forwarded messages for messages that were posted by a particular micro-blog user or member, for example. Thus, short informal messages of a member with a lower deviation value may be expected to be forwarded more consistently. In addition, a number of forwarded messages for messages posted by a particular micro-blog user or member may be determined and represented via a φᵣₜ feature. Also, a number of short informal messages posted by a particular micro-blog user or member represented by a φ_{tweet} feature may be generated or considered. It should be appreciated, as indicated previously, that a virtually limitless set of various other statistical measures or metrics such as, for example, a median, a ratio, a rate, an entropy, etc., may be used to generate one or more user-level features.

TABLE 4
Example user-level features.

| | |
|---|---|
| φₘₑₐₙ_{_{—}}ᵣₜ | a mean value of forwarded short informal messages for |
| | messages posted |
| φ_{sd}_{_{—}}ᵣₜ | a standard deviation value of forwarded messages for |
| | messages posted |
| φᵣₜ | a number of forwarded messages for messages posted |
| φ_{tweet} | a number of short informal messages posted |

TABLE 5
Example micro-blog users featuring higher
mean value of forwarded messages.

| userID | User/Type |
|---|---|
| shitmydadsays | Pop Culture |
| barackobama | Politics |
| revrunwisdom | Spiritual |
| pink | Music |
| tfln | Texts from Last Night |
| thecharlieday | Charlie Day |
| themime | Entertainment |
| theonion | News |
| wordpress | Product |
| iphone_dev | Product |
| tinybuddha | Spiritual |

In certain example implementations, one or more features relating to a measure or score representing a user social network authority may be generated based, at least in part, on relationships between “followed” members or users and “following” users or “followers” (e.g., “following” relationships). As was indicated, a “following” user of “follower” may refer to a micro-blog user or member who chose to “follow” one or more other users or members of a social network, for example, by signing up or subscribing to those users' or members' accounts or feeds to receive status updates in the form of short informal messages. In turn, a user or member whose posts or short informal messages are being followed may be referred to as, for example, a “followed” user or member, and typically, although not necessarily, may include a message originator or author. Of course, descriptions of “following” or “followed” micro-blog users or members are merely examples, and claimed subject matter is not limiter in this regard. Other techniques or approaches to measure or score user network authority may likewise be employed.

Although claimed subject matter is not limited in scope in this respect, in a micro-blogging communication context, user or member relationship information may be represented, for example, as a social network (e.g., having an interrelated link structure, etc.) where vertices may represent micro-blog users or members and edges may represent a “following” relationship between them. For example, user relationship information may be captured, for example, as a “following” relationship graph or other representation, such as in the form of an m×m adjacency matrix W, where Wᵢⱼ=1 if user i follows user j. It should be noted that in some implementations, W may be normalized so that ΣⱼWᵢⱼ=1.

Given a matrix and an eigensystem, Wπ=λπ, an eigenvector π associated with a sample eigenvalue, such as an extreme eigenvalue λ (e.g., a larger eigenvalue, largest eigenvalue, etc.), may be employed to provide a measure of social network authority or centrality of a micro-blog user or member, for example.

Although claimed subject matter is not limited in scope in this respect, in an implementation, an eigenvector π may be computed using, for example, the following iteration or a similar approach:

πₜ₊₁=(πW+(1−λ)U)πₜ (3)

where U is a matrix whose entries are all

$$\frac{1}{m} .$$

An interpolation of W with U typically will produce a stationary solution, π. As one simple example, without intending to limit the scope of claimed subject matter, an interpolation parameter π of 0.85 may be used, and fifteen iterations may be performed (e.g., \tilde{π}=π₁₅). Of course, for certain implementations, one or more sources of information updated or monitored in real-time may lack “following” relationship information, such as, for example, a streaming API of micro-blog Twitter. If desired, however, a crawl of network resources, such as, for example, a large-scale crawl of social network resources may be performed so as to capture suitable or desired “following” relationship information. Of course, claimed subject matter is not so limited in scope.

A measure of social network authority captured, for example, via Relation 3 may be represented by a social network authority feature φᵤₛₑᵣ_{_{—}}ᵣₐₙₖ accounting for number of “following” users or “followers” with respect to one or more “followed” members for an interrelated link structure of a particular social network, for example. A social network authority feature φᵤₛₑᵣ_{_{—}}ᵣₐₙₖ, thus, may take advantage of a non-limiting observation that micro-blog users or members with a higher number of “followers” tend to compose or create messages with a higher instances of re-posting or forwarding.

As a way of illustration and following the discussion above, \tilde{π} was computed for ten million users of micro-blog Twitter. Some examples of micro-blog users or members with a higher value of \tilde{π} are depicted in Table 6 below via a Markov chain analysis on a micro-blog “follower” graph representation, although claimed subject matter is not limited in scope in this respect. Popular micro-bloggers, technology authorities, as well as news or media sources were identified as authoritative, although, again, this is merely an example.

TABLE 6
Example micro-blog users featuring higher φᵤₛₑᵣ_{_{—}}ᵣₐₙₖ value

| userID | User/Type |
|---|---|
| twitter | Twitter Official |
| kimkardashian | Kim Kardashian |
| aplusk | Ashton Kutcher |
| denise_richards | Denise Richards |
| ddlovato | Demetria Lovato |
| katyperry | Katy Perry |
| khloekardashian | khloe Kardashian |
| johncmayer | John Mayer |
| astro_mike | Mike Massimino |
| robdyrdek | Rob Dyrdek |
| . . . | . . . |
| nasa | NASA Space Program |
| mcuban | Mark Cuban |
| wired | Wired Magazine |
| problogger | Darren Rowse |
| chrispirillo | Chris Pirillo |
| cbsnews | CBS News |
| jkottke | Jason Kottke |

It should be appreciated that one or more content-level features, user-level features, or social network authority features, for example, as provided previously, represent illustrative examples of filtering features that may be designed or identified according to one or more implementations. However, a variety of other filtering features may be employed in other embodiments or implementations in accordance with claimed subject matter.

As previously mentioned, an example process associated with micro-blog message filtering may include, for example, training one or more machine-learned functions. In the context of micro-blog message filtering, one or more machine-learned functions may include, for example, at least one prediction function trained to predict re-posting or forwarding one or more short informal messages within at least one social network, or at least one ranking function trained to determine a ranking order of socially relevant short informal messages in response to a query, as was previously indicated. In an implementation, an example process may include training a machine-learned function, partially, dominantly, or substantially, in a supervised learning setting. Optionally or alternatively, a machine-learned function may be trained, in whole or in part, without editorial oversight (e.g., in an unsupervised mode). Of course, these are merely examples relating to training one or more machine-learned functions, and claimed subject matter is not so limited.

In one particular implementation, a Gradient Boosted Decision Tree (GBDT) function may be used, for example, to learn or establish a prediction function that may be utilized, partially, dominantly, or substantially, to efficiently or effectively predict re-posting or forwarding one or more short informal messages within at least one social network. It should be noted that other functions or techniques capable of producing or establishing a prediction function such as, for example, via logistic loss or regression operation or the like, as examples, may also be utilized. Claimed subject matter is not limited to one particular technique or approach.

For purposes of explanation, a GBDT may comprise an additive classification or regression function comprising an ensemble of trees, fit to current residuals, gradients of a loss function, in a forward iterative or sequenced manner. A GBDT function may be iteratively fit to an additive model or operation as:

$${f}_{t} ( x ) = {T}_{t} ( x ; Θ ) + λ {\sum }_{t = 1}^{T} {β}_{t} {T}_{t} ( x ; {Θ}_{t} )$$

such that a loss function L(yᵢ,ƒ_{T}(x+1)) may be reduced, where Tᵢ(x;Θₜ) denotes a tree at iteration t, weighted by parameter β, with a finite number of parameters Θₜ, and λ denotes a learning rate. At iteration t, tree Tₜ(x;β) may be induced to fit a negative gradient by least squares, for example. That is:

$$\hat{Θ} := arg {min}_{β} {\sum }_{i}^{N} {( - {G}_{it} - {β}_{t} {T}_{t} ( {x}_{i} ) ; Θ )}^{2}$$

where Gᵢₜ denotes a gradient over a current prediction function as:

$${G}_{it} = {[ \frac{d L ( {y}_{i} , f ( {x}_{i} ) )}{d f ( {x}_{i} )} ]}_{f = {f}_{t - 1}}$$

Weights for trees βₜ may be determined by or in accordance with:

$${β}_{t} = arg {min}_{β} {\sum }_{i}^{N} L ( {y}_{i} , {f}_{t - 1} ( {x}_{i} ) + β T ( {x}_{i} , θ ) )$$

A node in a tree may represent a split on a feature. One or more tunable or modifiable parameters in a machine-learned function may include, for example, a number of leaf nodes in a tree, a relative contribution of score from a tree (e.g., a shrinkage), and a number of shallow decision trees, just to name a few examples.

Thus, a relative importance of a feature Sᵢ, for example, for predicting micro-blog message forwarding in forests of decision trees may be aggregated over m shallow decision trees as follows:

$${S}_{i}^{2} = \frac{1}{M} {\sum }_{m = 1}^{M} {\sum }_{n = 1}^{L - 1} \frac{{w}_{l} * {w}_{r}}{{w}_{l} + {w}_{r}} {( {y}_{l} {y}_{r} )}^{2} I ( {v}_{t} = i ) \qquad ( 4 )$$

where uₜ denotes a feature on which a split occurs, yₗ and yᵣ denote mean regression responses from right and left sub-trees, respectively, and wₗ and wᵣ denote corresponding weights for means, as measured by the number of training examples traversing left and right sub-trees.

For example, applying the approach above, 20 trees with 15 leaf nodes and a shrinkage parameter of 0.1 were used. In this example, a prediction function may be trained using a collection of short informal messages representing previous user behavior information or, optionally or alternatively, an index representing “following” relationship information. From this approach, it appears that example content-level and user-level features in conjunction with accessing previous or historic user behavior information may be beneficial in effectively or efficiently predicting micro-blog message forwarding. For example, relative ranking of example content-level features and user-level features may include those shown in Table 7 and Table 8 below, respectively. Example features are listed or presented based, at least in part, on relative feature scoring or rank within respective feature models or operations (e.g., content-only, user-only, etc.), though claimed subject matter is not so limited.

TABLE 7
Example content-level features.

| Feature | Category | Rank |
|---|---|---|
| φ_{tinyurl} | Content | 1 |
| φₗₘ_{_{—}}_{div} | Content | 2 |
| φₗₘ_{_{—}}_{sub} | Content | 3 |
| φ_{reply} | Content | 4 |
| φₗₘ_{_{—}}ᵣₜ | Content | 5 |
| φₗₘ_{_{—}}ₙₒᵣₜ | Content | 6 |

TABLE 8
Example user-level features.

| Feature | Category | Rank |
|---|---|---|
| φₘₑₐₙ_{_{—}}ᵣₜ | User | 1 |
| φᵣₜ | User | 2 |
| φ_{tweet} | User | 3 |
| φ_{sd rt} | User | 4 |

In one example, a process associated with micro-blog message filtering may include training at least one ranking function that may be utilized, in whole or in part, in connection with real-time information searching or indexing, for example. As an example, sample values of training information may comprise, for example, a plurality of <query, message> tuples having corresponding filtering features and editorially labeled relevance grades or scores. As a way of illustration, a tuple may be labeled by a human editor with a grade or score based, at least in part, on a perceived degree of relevance in terms of intent, usefulness, content, domain authority, or any combination thereof. By way of example, four judgment grades, such as “excellent,” good,” “fair,” or “bad” may be applied to a <query, message> tuple, to illustrate one possible implementation. In an example, queries including breaking news queries or short informal messages or posts for editorial judgments were identified through one or more text-matching procedures. It should be appreciated, of course, that various text-matching procedures (e.g., Karp-Rabin, Boyer-Moore, Knuth-Morris-Pratt, etc.) may be considered. In addition, for short informal messages or posts with an embedded resource identifier, such as a URL (e.g., in a shortened form, etc.), relevance of a URL may be considered for an overall editorial grade or score, for example, by navigating to and evaluating a relevance of a resource pointed to by a URL. Of course, descriptions relating to obtaining <query, message> tuples are merely examples.

In an implementation, a ranking function may be trained using one or more sample feature sets (e.g., user-level features, content-level features, social network authority feature, etc.) as well as editorial grades or scores associated with corresponding <query, message> tuples. In an example, a GBDT function, a learning task defined in connection with Relation 4 above, for example, may be employed to learn a ranking function that may be utilized or employed at query time, for example. It should be noted that various other functions or techniques for learning or establishing a ranking function may also be utilized. For example, any combination of filtering features or certain text-matching features (e.g., term frequency-inverse document frequency (TF-IDF), BM25, BM25F features, etc.) along with editorial grades may also be used to train one or more ranking functions to facilitate or support one or more processes associated with micro-blog message filtering.

By way of example but not limitation, in another example, 500 trees with 18 leaf nodes per tree and a shrinkage parameter of 0.06 were used. Some examples of filtering features are illustrated in Table 9 below listed based, at least in part, on relative feature score or rank.

TABLE 9
Example ranking filtering features.

| Feature | Category | Rank |
|---|---|---|
| φₗₘ_{_{—}}ₙₒᵣₜ | Content | 6 |
| φₗₘ_{_{—}}_{div} | Content | 7 |
| φₗₘ_{_{—}}ᵣₜ | Content | 8 |
| φₗₘ_{_{—}}_{sub} | Content | 9 |
| φ_{tweet} | User | 11 |
| φᵤₛₑᵣ_{_{—}}ᵣₐₙₖ | Authority | 13 |
| φₘₑₐₙ_{_{—}}ᵣₜ | User | 14 |
| φᵣₜ | User | 15 |
| φ_{sd}_{_{—}}ᵣₜ | User | 19 |

As seen, it appears that example filtering features based, at least in part, on historic forwarding behavior of networking parties within a particular social micro-blogging network may be beneficial in handling real-time queries while ranking socially relevant short informal messages or posts. Of course, this is just an example to which claimed subject matter is not limited.

Thus, one or more example features may be taken into consideration, in whole or in part, to facilitate or support one or more micro-blog message filtering techniques, for example, with respect to ranking micro-posts during real-time searching, for example. More specifically, in one particular implementation, a filtering task or operation may be performed in response to a query, for example, so as to identify one or more representative terms present or embedded in a post (e.g., candidate for ranking, etc.) corresponding to one or more filtering features (e.g., indexed in a search index, database, etc.) that may be relevant to the query. One or more representative terms may be processed by a ranking function, for example, and socially relevant messages may be ranked and presented based, at least in part, on a determined or scored order of relevance to a query by considering contributions from one or more filtering features intended to capture or identify relevance between a query and a message, for example. Of course, details of ranking short informal messages or posts during real-time information searches are provided merely as an example, and claimed subject matter is not so limited.

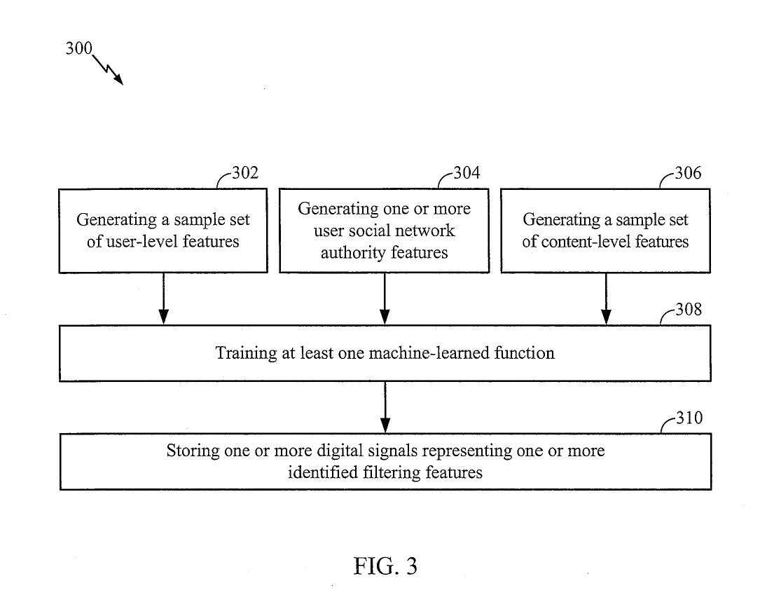

Attention is drawn next to FIG. 3, which is a flow diagram illustrating an embodiment of an example process 300 that may be implemented by one or more special purpose computing devices, partially, dominantly, or substantially, to facilitate or support one or more processes associated with micro-blog message filtering. Example process 300 may begin, for example, with generating one or more sample sets of filtering features represented by one or more digital signals. As was indicated, one or more sample sets may be generated based, at least in part, on past or previous (e.g., historic, etc.) behavior information, for example, in the form of digital signal information, of parties or members with respect to posting and re-posting or forwarding short informal messages within a particular social network, such as, for example, a micro-blogging social network. As was also discussed, social networking relationships between, for example, “followed” users and “following” users (e.g., “following” relationships) may also be considered.

Thus, at operation 302, a sample set of user-level features may be generated, such as electronically, in connection with operation of a special purpose computing device or system, for example. As seen, at operation 304, one or more user social network authority features may likewise be generated, again, such as electronically, in connection with operation of a special purpose computing device or system, for example. As also illustrated, at operation 306, a sample set of content-level features may be generated, again, such as electronically, in connection with operation of a special purpose computing device or system, for example. With regard to operation 308, at least one machine-learned function may be trained based, at least in part, on one or more information samples associated with one or more sets of features. In certain implementations, at least one machine-learned function may be trained, for example, to identify at least one feature predicting that a short informal message may be forwarded or may be more likely to be forwarded within at least one social network, as was previously mentioned. In one particular implementation, at least one ranking function may be trained, for example, in connection with real-time information searching or indexing, as was described previously. At operation 310, one or more digital signals representing one or more identified filtering features that may be employed in the manner previously described, may be stored, for example, such as in IIS 102 of FIG. 1. Thus, one or more identified filtering features may be stored in memory as part of an index, such as, for example, search index 126 of FIG. 1, though claimed subject matter is not so limited. Optionally or alternatively, one or more identified features may be stored via a storage medium, such as database 116 of FIG. 1, for example, which may provide stored signal information to an index, to illustrate another possible implementation. In one particular implementation, an index may be accessed, for example, by a classifier or like process or function (e.g., a prediction function, etc.) to classify a short informal message as one more likely to be forwarded. In another implementation, signal information stored in an index (e.g., identified filtering features, representative terms, indicator terms, classification results, etc.) may be accessed or used, for example, by a ranking function to determine an order or a scoring of relevance of short informal messages to a query. Results of a micro-blog message filtering may be implemented for use with a search engine or other like information management systems, for example, responsive to search queries.

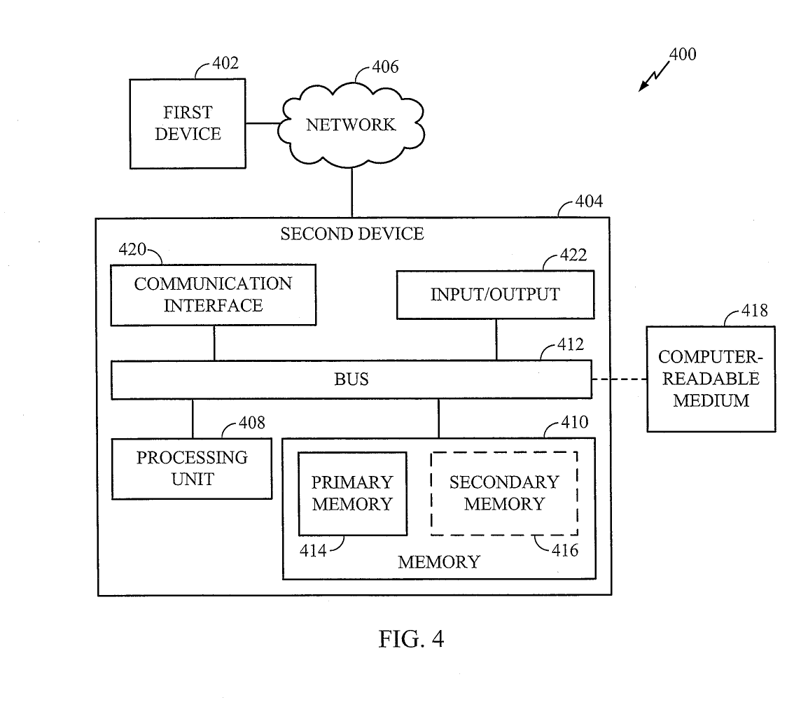

FIG. 4 is a schematic diagram illustrating an example computing environment 400 that may include one or more devices that may be capable of implementing a process for micro-blog message filtering, partially, dominantly, or substantially, for example, in the context of social networking, micro-blogging, or information searching, or the like.

Computing environment system 400 may include, for example, a first device 402 and a second device 404, which may be operatively coupled together via a network 406. In an embodiment, first device 402 and second device 404 may be representative of any electronic device, appliance, or machine that may have capability to exchange signal information over network 406. Network 406 may represent one or more communication links, processes, or resources having capability to support exchange or communication of signal information between first device 402 and second device 404. Second device 404 may include at least one processing unit 408 that may be operatively coupled to a memory 410 through a bus 412. Processing unit 408 may represent one or more circuits to perform at least a portion of one or more signal information computing procedures or processes.

Memory 410 may represent any signal storage mechanism. For example, memory 410 may include a primary memory 414 and a secondary memory 416. Primary memory 414 may include, for example, a random access memory, read only memory, etc. In certain implementations, secondary memory 416 may be operatively receptive of, or otherwise have capability to be coupled to, a computer-readable medium 418.

Computer-readable medium 418 may include, for example, any medium that can store or provide access to signal information, such as, for example, code or instructions for one or more devices in system 400. It should be understood that a storage medium may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, to illustrate one possible implementation. As such, “non-transitory” may refer, for example, to any medium or device remaining tangible despite this change in state.

Second device 404 may include, for example, a communication adapter or interface 420 that may provide for or otherwise support communicative coupling of second device 404 to a network 406. Second device 404 may include, for example, an input/output device 422. Input/output device 422 may represent one or more devices or features that may be able to accept or otherwise input human or machine instructions, or one or more devices or features that may be able to deliver or otherwise output human or machine instructions.

According to an implementation, one or more portions of an apparatus, such as second device 404, for example, may store one or more binary digital electronic signals representative of information expressed as a particular state of a device such as, for example, second device 404. For example, an electrical binary digital signal representative of information may be “stored” in a portion of memory 410 by affecting or changing a state of particular memory locations, for example, to represent information as binary digital electronic signals in the form of ones or zeros. As such, in a particular implementation of an apparatus, such a change of state of a portion of a memory within a device, such a state of particular memory locations, for example, to store a binary digital electronic signal representative of information constitutes a transformation of a physical thing, for example, memory device 410, to a different state or thing.

Thus, as illustrated in various example implementations or techniques presented herein, in accordance with certain aspects, a method may be provided for use as part of a special purpose computing device or other like machine that accesses digital signals from memory or processes digital signals to establish transformed digital signals which may be stored in memory as part of one or more information files or a database specifying or otherwise associated with an index.

Some portions of the detailed description herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels.

Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described or shown herein using various methods or systems, it should be understood by those skilled in the art that various other modifications may be made, or equivalents may be substituted, without departing from claimed subject matter. Additionally, many modifications may be made to adapt a particular situation to the teachings of claimed subject matter without departing from the central concept(s) described herein. Therefore, it is intended that claimed subject matter not be limited to particular examples disclosed, but that claimed subject matter may also include all implementations falling within the scope of the appended claims, or equivalents thereof.

What is claimed is:

1. A method comprising:
predicting one or more re-tweet messages based, at least in part, on applying one or more filtering features to a set of short informal messages, said filtering features comprising at least one of the following: one or more user-level features; one or more content-level features; one or more social network authority-level features; or any combination thereof.

2. The method of claim 1, wherein said predicting one or more re-tweet messages comprises applying one or more prediction functions to identify potential re-tweet messages from said set of short informal messages, wherein said set of short informal messages comprises electronic messages transmitted within one or more social networks.

3. The method of claim 1, wherein applying said one or more user-level features comprises identifying one or more user-related terms in said set of short informal messages.

4. The method of claim 1, wherein applying said one or more content-level features comprises identifying one or more indicator terms in said set of short informal messages.

5. The method of claim 1, wherein applying said one or more social network authority-level features comprises identifying one or more users as a social network authority and identifying short informal messages in said set as having been transmitted by said one or more identified users.

6. A method comprising:
electronically classifying one or more features to be applied to one or more short informal messages transmitted within one or more social networks as features capable of identifying transmitted short informal messages more likely to be forwarded.

7. The method of claim 6, wherein said one or more features are based, at least in part, on applying one or more machine-learned functions to a set of short informal training messages.

8. The method of claim 6, wherein said one or more features are also capable of ranking the identified short informal messages more likely to be forwarded.

9. The method of claim 7, wherein said applying one or more machine-learned functions to a set of short informal training messages produces one or more prediction functions.

10. An article comprising: a storage medium having stored thereon instructions executable by a special-purpose computing system to: predict one or more re-tweet messages based, at least in part, on applying one or more filtering features to a set of short informal messages, said filtering features comprising at least one of the following: one or more user-level features; one or more content-level features; one or more social network authority-level features; or any combination thereof.

11. The article of claim 10, wherein said instructions are further executable to: apply one or more prediction functions to identify potential re-tweet messages from said set of short informal messages, wherein said set of short informal messages comprises electronic messages transmitted within one or more social networks.

12. The article of claim 10, wherein said instructions are further executable to: apply said one or more user-level features to identify one or more user-related terms in said set of short informal messages.

13. The article of claim 10, wherein said instructions are further executable to: apply said one or more content-level features to identify one or more indicator terms in said set of short informal messages.

14. The article of claim 10, wherein said instructions are further executable to: apply said one or more social network authority-level features to identify one or more users as a social network authority and identify short informal messages in said set as having been transmitted by said one or more identified users.

15. An article comprising: a storage medium having stored thereon instructions executable by a special-purpose computing system to: electronically classify one or more features to be applied to one or more short informal messages transmitted within one or more social networks as features capable of identifying transmitted short information messages more likely to be forwarded.

16. The article of claim 10, wherein said instructions are further executable to: rank the identified short informal messages more likely to be forwarded.

17. The article of claim 10, wherein said instructions are further executable to: determine one or more prediction functions.

18. An apparatus comprising: a special purpose computing system;
said special purpose computing system to predict one or more re-tweet messages based, at least in part, on applying one or more filtering features to a set of short informal messages, said filtering features comprising at least one of the following: one or more user-level features; one or more content-level features; one or more social network authority-level features; or any combination thereof.

19. The apparatus of claim 18, wherein said special purpose computing system to apply one or more prediction functions to identify potential re-tweet messages from said set of short informal messages, wherein said set of short informal messages comprises electronic messages transmitted within one or more social networks.

20. The apparatus of claim 18, wherein said special purpose computing system to apply said one or more user-level features to identify one or more user-related terms in said set of short informal messages.

21. The apparatus of claim 18, wherein said special purpose computing system to apply said one or more content-level features to identify one or more indicator terms in said set of short informal messages.

22. The apparatus of claim 18, wherein said special purpose computing system to apply said one or more social network authority level features to identify one or more users as a social network authority and identify short informal messages in said set as having been transmitted by said one or more identified users.
